(19) United States
(12) Patent Application Publication
(10) Pub. No.: US 2017/0212582 A1
(43) Pub. Date: Jul. 27, 2017

(54) USER INTERFACE SELECTION

(71) Applicant: Cisco Technology, Inc., San Jose, CA (US)

(72) Inventor: Fredrik Oledal, Oslo (NO)

(21) Appl. No.: 15/002,430

(22) Filed: Jan. 21, 2016

(51) Int. Cl. G06F 3/01; G06F 3/0481; G06F 3/0484; G06F 3/038

(52) U.S. Cl. CPC G06F 3/012; G06F 3/013; G06F 3/038; G06F 3/04812; G06F 3/04842

(57) ABSTRACT

In one embodiment, a system includes a data bus to receive first tracking data from a first tracking device and second tracking data from a second tracking device, a hardware processor to calculate a first position of a first symbol on a display using the first tracking data, calculate a second position of a second symbol on the display using the second tracking data, compare a proximity of the first and second position on the display, and in response to the first position and the second position having a predetermined proximity to each other on the display, perform a selection command, and a graphics processing unit to generate an image of the first symbol and an image of the second symbol for output to a display device for display, at the first position and the second position, respectively. Related apparatus and methods are also described.

### TECHNICAL FIELD

The present disclosure generally relates to performing selection commands.

### BACKGROUND

While the most common pointing device by far is the mouse, many more devices have been developed. A “rodent” is a technical term referring to a device which generates mouse-like input. However, the term “mouse” is commonly used as a metaphor for devices that move the cursor. Other pointing devices include a joystick, pointing stick, stylus, touchpad, touchscreen, eye tracker and head-position tracker to name but a few. Each pointing device may include a button or an associated gesture which effect a “mouse click” or selection command.

### BRIEF DESCRIPTION OF THE DRAWINGS

The present disclosure will be understood and appreciated more fully from the following detailed description, taken in conjunction with the drawings in which:

FIG. 1 is a partly pictorial, partly block diagram view of a user interface selection system constructed and operative in accordance with an embodiment of the present disclosure;

FIG. 2 is a partly pictorial, partly block diagram view of the user interface selection system of FIG. 1 performing a selection command; and

FIG. 3 is a flow chart of exemplary steps in a method of operation on the system of FIG. 1.

### DESCRIPTION OF EXAMPLE EMBODIMENTS

### Overview

There is provided in accordance with an embodiment of the present invention, a system including a data bus to receive first tracking data from a first tracking device and second tracking data from a second tracking device, a hardware processor to calculate a first position of a first symbol on a display using the first tracking data, calculate a second position of a second symbol on the display using the second tracking data, compare a proximity of the first position and the second position on the display, and in response to the first position and the second position having a predetermined proximity to each other on the display, perform a selection command, and a graphics processing unit to generate an image of the first symbol and an image of the second symbol for output to a display device for display, at the first position and the second position, respectively.

### DETAILED DESCRIPTION

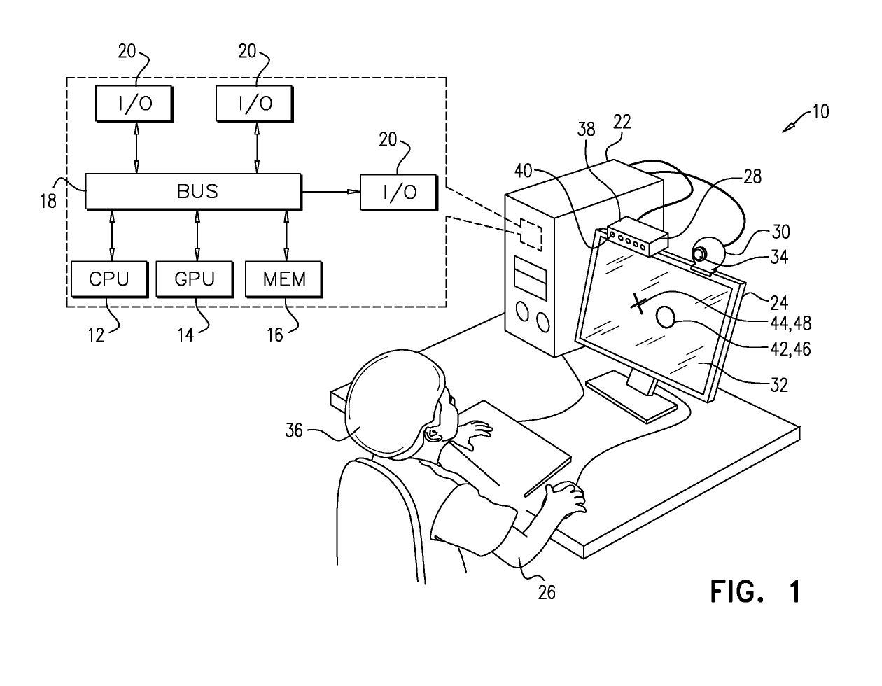

Reference is now made to FIG. 1, which is a partly pictorial, partly block diagram view of a user interface selection system 10 constructed and operative in accordance with an embodiment of the present disclosure. The user interface selection system 10 may include a hardware processor (for example, but not limited to, a central processing unit (CPU) 12), a graphics processing unit (GPU) 14, a memory 16, a data bus 18 and a plurality of input/output interfaces 20. The user interface selection system 10 may be implemented as part of a computing device 22 which is operationally connected to a display device 24. The computing device 22 may or may not be integrated with the display device 24. The computing device 22 may be any suitable computing device 22, for example, but not limited to, a desk top computer, lap top computer, tablet device or smart phone. The display device 24 may be connected to the data bus 18 via one of the input/output interfaces 20.

The central processing unit 12 is operative to process pointing commands received from a user 26 described in more detail below. The central processing unit 12 is operative to run other system and application software. The memory 16 is operative to store data used by the central processing unit 12 and optionally the graphics processing unit 14. The data bus 18 is operative to connect the various elements of the user interface selection system 10 for data transfer purposes. The data bus 18 is operative to receive tracking data from a first tracking device 28 and tracking data from a second tracking device 30. The first tracking device 28 and the second tracking device 30 may be connected to the user interface selection system 10 by any suitable wired or wireless connection. Alternatively, the first tracking device 28 and/or second the tracking device 30 may be integrated within the user interface selection system 10. The tracking devices 28, 30 may be connected to the data bus 18 via the input/output interfaces 20.

Each tracking device 28, 30 may be any suitable tracking device for example, but not limited to an eye gaze tracking device for tracking eye movements, a head position and orientation tracking device for tracking head position and orientation, a gesture tracking device for tracking hand movements, a wired or wireless mouse etc. The type of tracking device selected for the first tracking device 28 is different to the type of tracking device selected for the second tracking device 30.

When one of the tracking devices 28, 30 includes an eye gaze tracking device, the tracking device 28, 30 may include a suitably positioned camera 34 which sends images to the central processing unit 12 for calculating a corresponding position of where the user 26 is looking at on a screen 32 (display) of the display device 24. Alternatively, the tracking device 28, 30 may pre-process the images received from the camera 34. The data pre-processed by the tracking device 28, 30 may then be sent to the central processing unit 12 for further position processing.

When one of the tracking devices 28, 30 includes a head position and orientation tracking device, the tracking device 28, 30 may include a suitably positioned camera (e.g. the camera 34) which sends images to the central processing unit 12 for calculating a corresponding position and orientation of the head of the user 26 with respect to the screen 32 of the display device 24, thereby providing an indication of where the user 26 is facing across from the screen 32. Alternatively, the tracking device 28, 30 may pre-process the data received from the camera 34. The data pre-processed by the tracking device 28, 30 may then be sent to the central processing unit 12 for further position and/or orientation processing.

Alternatively, when one of the tracking devices 28, 30 includes a head position and orientation tracking device, the tracking device 28, 30 may include a helmet 36 worn by the user 26 and a tracking box 38. The helmet 36 may include transmitters (not shown) which send signals that are received by a plurality of sensors 40 (only one labeled for the sake of simplicity) in the tracking box 38. The helmet 36 may include accelerometers among other elements. The data received by the sensors 40 may be transmitted to the central processing unit 12 for calculating a corresponding position and orientation of the head of the user 26 with respect to the screen 32 of the display device 24 using any suitable position algorithm for example, but not limited to, using triangulation, thereby providing an indication of where the user 26 is facing across from the screen 32. Alternatively, the tracking device 28, 30 may pre-process the data received from the sensors 40. The data pre-processed by the tracking device 28, 30 may then be sent to the central processing unit 12 for further position and/or orientation processing. The sensors may alternatively be disposed in the helmet 36 and the tracking box 38 may include transmitters.

The central processing unit 12 is operative to calculate a first position of a symbol 42 on the screen 32 (or on any suitable display, for example if the display output is projected) using the tracking data from the first tracking device 28 and to calculate a second position of a symbol 44 on the screen 32 using the tracking data from the second tracking device 30. The first position and the second position may, by way of example, correspond to where the eyes of user 26 are looking at on the screen 32 and where the head of the user 26 is facing across from the screen 32, respectively.

The graphics processing unit 14 is operative to generate an image 46 of the symbol 42 and an image 48 of the symbol 44 for output to the display device 24 for display, at the first position and the second position, respectively. The graphics processing unit 14 may be implemented as part of the central processing unit 12 or as a separate graphics hardware processor. Each image 46, 48 is similar to a cursor displaying the positions of where the user is pointing to on the screen 32.

The symbol 42 and the symbol 44 may be any suitable symbol. The symbol 42 and symbol 44 are designed such that the symbol 42 may fit inside or may fully encompass the symbol 44 when displayed on the screen 32. Alternatively, the symbol 42 and symbol 44 are designed such that the symbol 44 may fit inside or may fully encompass the symbol 42 when displayed on the screen 32. Additionally, or alternatively, the symbol 42 may include two intersecting lines, for example, but not limited to an X or a cross symbol and the symbol 44 may include a closed loop, for example, but not limited to a circle or the symbol 44 may include two intersecting lines, for example, but not limited to an X or a cross symbol and the symbol 42 may include a closed loop, for example, but not limited to a circle. The symbol 42 and the symbol 44 may be displayed on the screen 32 at the first position and second position, respectively, such that the center of the symbol 42 is displayed at the first position and the center of the symbol 44 is displayed at the second position.

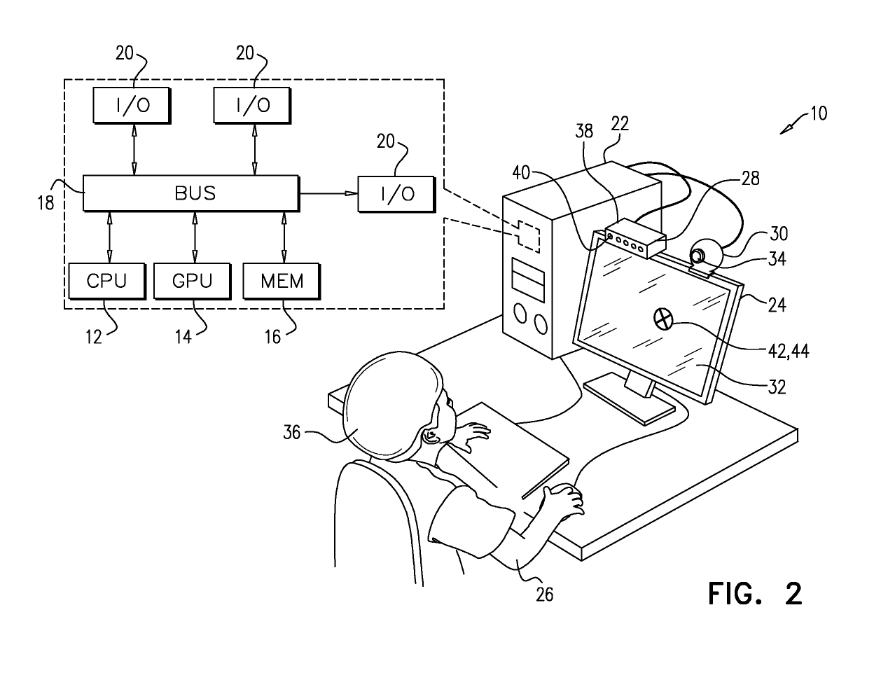

Reference is now made to FIG. 2, which is a partly pictorial, partly block diagram view of the user interface selection system 10 of FIG. 1 performing a selection command. A selection command is performed when the symbols 42, 44 are in a predetermined proximity to each other on the screen 32. The central processing unit 12 is operative to compare the proximity of the first position and the second position on the screen 32. The central processing unit 12 is operative, in response to the first position and the second position having a predetermined proximity to each other on the screen 32, perform a selection command, for example, but not limited to, selecting an item on the screen 32 at the position of the symbols 42, 44. As mentioned above, the center of the symbol 42 may be displayed at the first position and the center of the symbol 44 may be displayed at the second position, by way of example only. The proximity of the first position and the second position which activates a selection command may be measured in millimeters or in a number of pixels, by way of example only. The proximity which activates a selection command may be between 1 to 8 mm or 3 to 50 pixels by way of example only, but could be set at any suitable size. Alternatively, the proximity may be set according to the size of the selectable items on the screen. The proximity of the first position and the second position which activates a selection command may be determined when the symbol 42 is completely, or partially, inside the symbol 44, or vice-versa. It should be noted that “gazing” direction is generally more easily quantified by humans than “facing” direction. Any discrepancy between “gazing” and “facing” direction may be compensated for if the “gazing symbol” is big enough (for example, but not limited to 50 mm on a 24 inch screen) while relying on human symmetry intelligence in order to compensate for the discrepancy between “gazing” and “facing” direction. It should be noted that activation of the selection command may be performed as soon as the first and second position have the predetermined proximity. However, the selection command may be delayed until the first and second position have the predetermined proximity for more than a minimum time period, for example, but not limited to, a fraction of a second or 1 seconds or 2 seconds. The minimum time period may be configurable. It will be appreciated that the selection action may be selecting a selectable link, menu, button or placing a cursor at the position where the first and second position are within the predetermined proximity. If the symbols 42, 44 are close to more than one selectable item then the item closest to the center point between the first and second position is generally selected.

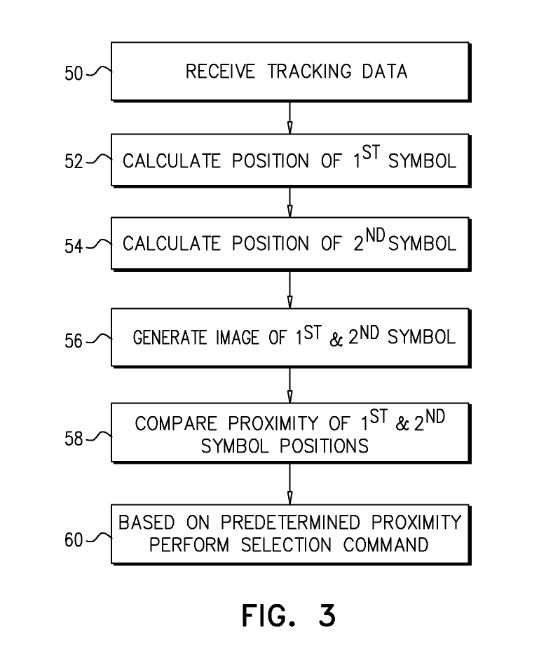

Reference is now made to FIG. 3, which is a flow chart of exemplary steps in a method of operation on the system 10 of FIG. 1. Reference is also made to FIG. 1. The method includes receiving tracking data from the first tracking device 28 and tracking data from the second tracking device 30 (block 50); calculating a first position of the symbol 42 on the screen 32 using the tracking data from the first tracking device 28 (block 52); calculating a second position of the symbol 44 on the screen 32 using the tracking data from the second tracking device 30 (block 54); generating the image 46 of the symbol 42 and the image 48 of the symbol 44 for output to the display device 24 for display, at the first position and the second position, respectively (block 56); comparing a proximity of the first position and the second position on the screen 32 (block 58); and in response to the first position and the second position having a predetermined proximity to each other on the screen 32, performing a selection command (block 60). Steps 50-60 are repeated on a periodic basis and may be performed in any suitable order.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively or additionally, the software may be stored in tangible, non-transitory computer-readable storage media, such as optical, magnetic, or electronic memory.

It is appreciated that software components may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present disclosure.

It will be appreciated that various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

It will be appreciated by persons skilled in the art that the present disclosure is not limited by what has been particularly shown and described hereinabove. Rather the scope of the disclosure is defined by the appended claims and equivalents thereof.

What is claimed is:

1. A system comprising:
a data bus to receive first tracking data from a first tracking device and second tracking data from a second tracking device;
a hardware processor to:
calculate a first position of a first symbol on a display using the first tracking data;
calculate a second position of a second symbol on the display using the second tracking data;
compare a proximity of the first position and the second position on the display; and
in response to the first position and the second position having a predetermined proximity to each other on the display, perform a selection command; and
a graphics processing unit to generate an image of the first symbol and an image of the second symbol for output to a display device for display, at the first position and the second position, respectively.

2. The system according to claim 1, wherein the first tracking device includes an eye gaze tracking device.

3. The system according to claim 1, wherein the second tracking device includes a head position and orientation tracking device.

4. The system according to claim 1, wherein the first tracking device includes an eye gaze tracking device and the second tracking device includes a head position and orientation tracking device.

5. The system according to claim 1, wherein the first symbol and the second symbol are designed such that the first symbol may fit inside or may fully encompass the second symbol when displayed on the display.

6. The system according to claim 1, wherein the first symbol includes two intersecting lines and the second symbol includes a closed loop.

7. The system according to claim 1, further comprising the first tracking device.

8. The system according to claim 1, further comprising the second tracking device.

9. A method comprising:
receiving first tracking data from a first tracking device;
receiving second tracking data from a second tracking device;
calculating a first position of a first symbol on a display using the first tracking data;
calculating a second position of a second symbol on the display using the second tracking data;
comparing a proximity of the first position and the second position on the display;
in response to the first position and the second position having a predetermined proximity to each other on the display, performing a selection command; and
generating an image of the first symbol and an image of the second symbol for output to a display device for display, at the first position and the second position, respectively.

10. The method according to claim 9, wherein the first tracking device includes an eye gaze tracking device.

11. The method according to claim 9, wherein the second tracking device includes a head position and orientation tracking device.

12. The method according to claim 9, wherein the first tracking device includes an eye gaze tracking device and the second tracking device includes a head position and orientation tracking device.

13. The method according to claim 9, wherein the first symbol and the second symbol are designed such that the first symbol may fit inside or may fully encompass the second symbol when displayed on the display.

14. The method according to claim 9, wherein the first symbol includes two intersecting lines and the second symbol includes a closed loop.

15. A software product, comprising a tangible computer-readable medium in which program instructions are stored, which instructions, when read by a processor, cause the processor to read an identification code from a memory, and to:
receive first tracking data from a first tracking device;
receive second tracking data from a second tracking device;
calculate a first position of a first symbol on a display using the first tracking data;
calculate a second position of a second symbol on the display using the second tracking data;
compare a proximity of the first position and the second position on the display;
in response to the first position and the second position having a predetermined proximity to each other on the display, perform a selection command; and
generate an image of the first symbol and an image of the second symbol for output to a display device for display, at the first position and the second position, respectively.

16. The software product according to claim 15, wherein the first tracking device includes an eye gaze tracking device.

17. The software product according to claim 15, wherein the second tracking device includes a head position and orientation tracking device.

18. The software product according to claim 15, wherein the first tracking device includes an eye gaze tracking device and the second tracking device includes a head position and orientation tracking device.

19. The software product according to claim 15, wherein the first symbol and the second symbol are designed such that the first symbol may fit inside or may fully encompass the second symbol when displayed on the display.

20. The software product according to claim 15, wherein the first symbol includes two intersecting lines and the second symbol includes a closed loop.
